(19) United States
(12) Patent Application Publication
(10) Pub. No.: US 2006/0243770 A1
(43) Pub. Date: Nov. 2, 2006

(54) Accessory quick-connect apparatus and method

(75) Inventors: Douglas Kortbein, Baraboo, WI (US); John Toutant, Brandon, WI (US); Brendan Doorhy, Westmont, IL (US); Jon Alling, Madison, WI (US)

Correspondence Address: GODFREY & KAHN S.C., 780 NORTH WATER STREET, MILWAUKEE, WI, 53202, US

(73) Assignee: Kolpin Powersports, Inc.

(21) Appl. No.: 11/120,130

(22) Filed: May 2, 2005

(51) Int. Cl. B60R 7/00; B60R 11/00; B60R 9/00

(52) U.S. Cl. 224/547; 224/42.32; 224/564

(57) ABSTRACT

An accessory quick-connect apparatus for a vehicle is disclosed. The system includes a base plate adapted for attachment to a vehicle, and at least one accessory plate adapted for removable attachment to the base plate and to at least one accessory for a vehicle. The accessory plate can be attached to and removed from the base plate without the use of tools.

### FIELD OF THE INVENTION

The present invention relates generally to accessories for vehicles, and more particularly to an accessory quick-connect apparatus for use with all-terrain vehicles.

### BACKGROUND OF THE INVENTION

There are a wide variety of accessories available for all-terrain vehicles. Some examples of available accessories include gun cases, cargo trays, luggage, saw and other tool mounting brackets, tree stands, water and fuel packs, and coolers. It is often necessary to secure these accessories to a rack or other section of the all-terrain vehicle for safe transport. Current systems for securing accessories to all-terrain vehicles generally involve attaching the accessory or a mounting bracket on the accessory to the vehicle using bolts, screws, nuts and other fastening devices that require the use of hand tools for installation and removal.

Although the accessories are secure using existing systems, the existing systems are time-consuming and inconvenient to install and remove. For example, when an all-terrain vehicle operator wishes to add additional water to a water pack, the operator must use hand tools to remove several traditional fastening devices such as nuts, bolts and screws to release the water pack from the all-terrain vehicle, and then must again use hand tools to reinstall the several fastening devices to replace the water pack on the all-terrain vehicle. In addition, it can be time-consuming and inconvenient to replace one accessory with another. If an operator, for instance, was last using the all-terrain vehicle on a hunting trip, a particular gun case might be attached to the vehicle. On the next hunting trip, the operator may need a different gun that requires a different case. Replacing the first gun case with the second gun case using existing systems requires the time-consuming removal and replacement of several fastening devices using hand tools.

Given the limitations and problems with the existing systems for mounting accessories to all-terrain vehicles, there exists a need for an improved system that allows for quick and easy attachment, removal and replacement of accessories on all-terrain vehicles. The present invention relates to improvements over the systems described above, and to solutions to the problems raised or not solved thereby.

### SUMMARY OF THE INVENTION

The present invention provides an accessory quick-connect apparatus for a vehicle. The apparatus includes a base plate and an accessory plate. The base plate is adapted for attachment to a vehicle, and the accessory plate is adapted for removable attachment to the base plate and to at least one accessory for a vehicle. The accessory plate can be removed from the base plate without the use of tools. A lever with a notch can be used to attach and remove the accessory plate from the base plate, and the accessory plate preferably slidably engages the base plate. Multiple accessory plates can be included with the apparatus of the present invention so as to allow quick and easy attachment of multiple accessories to the vehicle.

The present invention has several advantages over the existing systems for mounting accessories to all-terrain vehicles. In particular, the accessory plate carrying the accessory can be quickly and easily removed from the base plate, and thus from the all-terrain vehicle, without the use of hand tools. Accessories can also be easily replaced with other accessories by using a separate accessory plate for each accessory. Various other features, objects, and advantages of the invention will be made apparent to those skilled in the art from the accompanying drawings and detailed description thereof.

### BRIEF DESCRIPTION OF THE DRAWINGS

FIG. 1 is a perspective view of one embodiment of a quick-connect apparatus according to the present invention, installed on a rack of an all-terrain vehicle (not shown);

FIG. 2 is an exploded perspective view of the quick-connect apparatus of FIG. 1;

FIG. 3 is a cross-section of the quick-connect apparatus taken along plane 3-3 of FIG. 1, illustrating the secured position of the accessory plate, and showing the depressed position of the lever in phantom;

FIG. 4 is a cross-section of the quick-connect apparatus taken along plane 4-4 of FIG. 2, illustrating the released position of the accessory plate;

FIG. 5 is top plan view of one embodiment of the base plate of the quick-connect apparatus of the present invention;

FIG. 6 is a cross-section of the base plate taken along plane 6-6 of FIG. 5;

FIG. 7 is a perspective view of one embodiment of the quick-connect apparatus of the present invention installed on a rack of an all-terrain vehicle with a mounting bracket attached to the accessory plate;

FIG. 8 is a cross-section of the quick-connect apparatus taken along plane 8-8 of FIG. 7; and

FIG. 9 is a partial perspective view of one alternative embodiment of the quick-connect apparatus of the present invention, showing the use of a pin and cable fastening device.

### DETAILED DESCRIPTION OF THE INVENTION

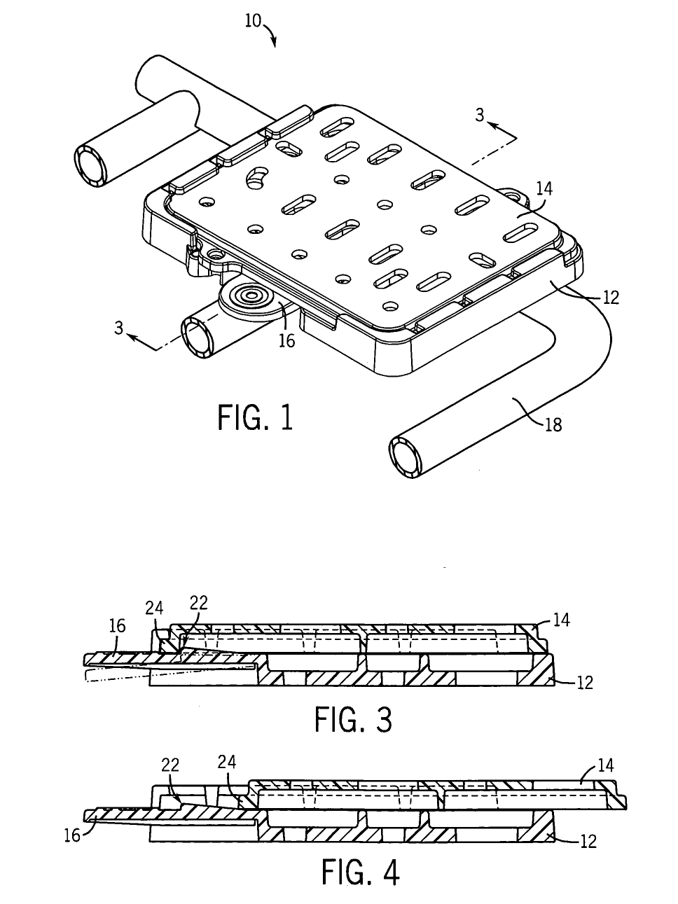

The present invention provides an accessory quick-connect apparatus for use in connection with all-terrain and other vehicles. As shown in FIGS. 1-9, the quick-connect apparatus 10 includes a base plate 12 and an accessory plate 14. The base plate 12 can be attached to the vehicle, and the accessory plate 14 can be attached to an accessory for the vehicle. The accessory plate 14 can be secured to and removed from the base plate 12 without the use of tools for quick and easy attachment, removal or replacement of accessories.

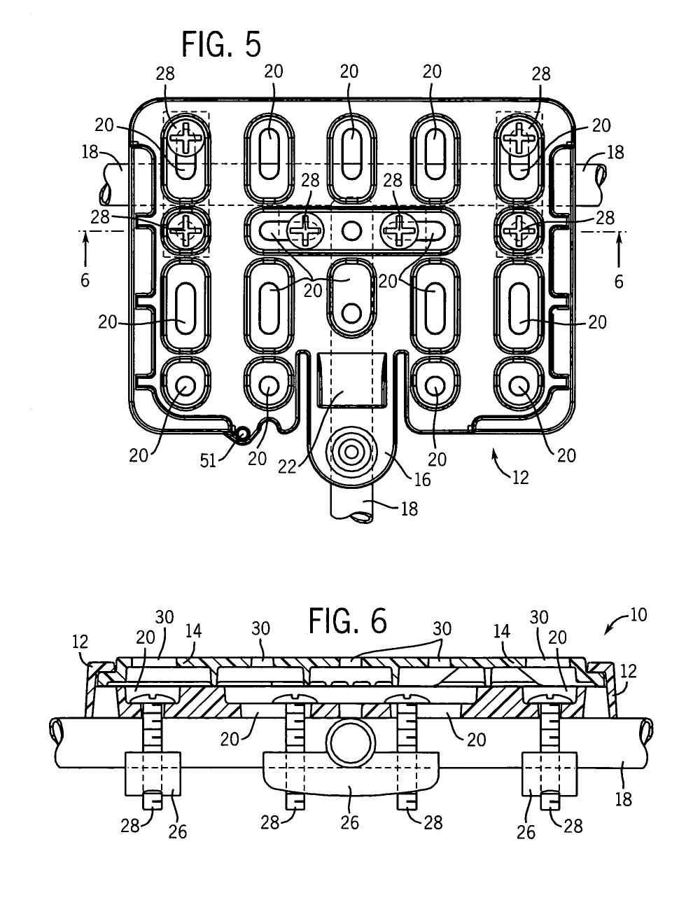

The base plate 12 and accessory plate 14 can have a number of configurations. One configuration for the base plate 12 and accessory plate 14 that has been found to be particularly effective is shown in FIGS. 1-9. The base plate 12 is a substantially flat, rectangular plate with a plurality of securement holes 20 to facilitate attachment of the base plate 12 to the vehicle. The base plate 12 preferably has a plurality of securement holes 20, but any number of securement holes 20, including a single securement hole 20, could be used. The securement holes 20 can also be of a variety of shapes and sizes to accommodate a wide variety of vehicles and a wide variety of mounting hardware. The base plate 12 can thus be attached to the vehicle in a number of ways. For example, the base plate 12 could be attached to a tubular rack 18 of an all-terrain vehicle using at least one cross-brace 26 and bolts 28. In FIGS. 5 and 6, three cross-braces 26 are used, however, any number of cross-braces could be used, as well as other mounting hardware. The cross-braces 26 are placed on one side of the rack 18, and the base plate 12 is placed on the other side of the rack 18. Bolts 28 are then used to connect the cross-braces 26 to the base plate 12, as shown in FIGS. 5 and 6, with each bolt 28 placed through a securement hole 20 in the base plate 12.

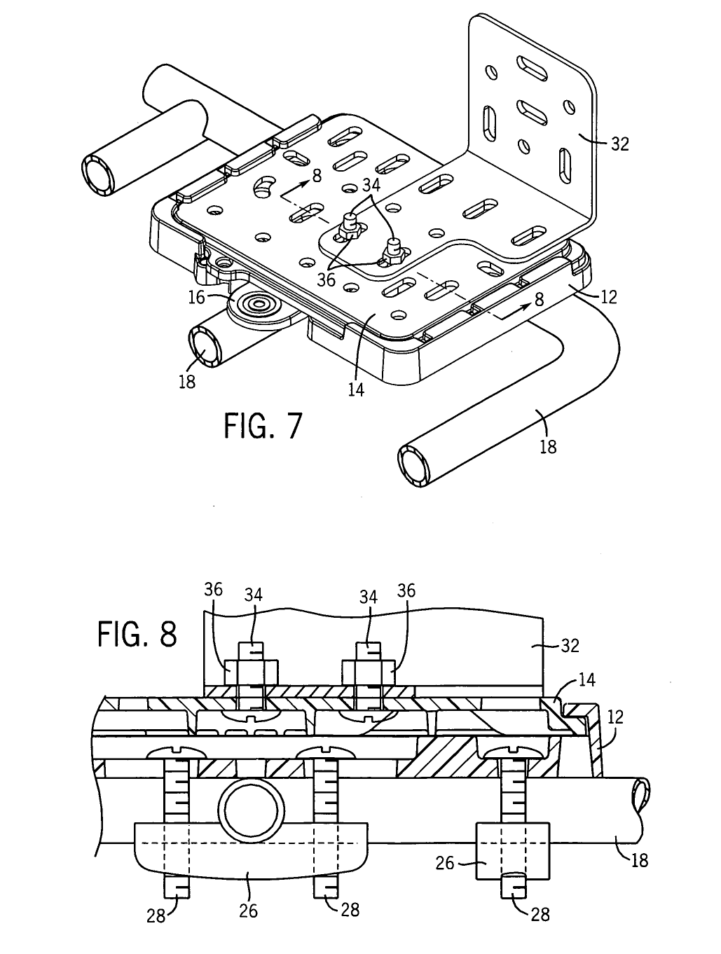

The accessory plate 14 shown in FIGS. 1-9 is also a substantially flat, rectangular plate. The accessory plate 14 has a plurality of openings 30 to facilitate attachment of accessories to the accessory plate 14. As noted above with respect to the securement holes 20, accessory plate openings 30 can be of a variety of shapes and sizes to accommodate a wide range of accessories and mounting hardware, and although a plurality of openings 30 are preferred for this reason, any number of openings 30 including a single opening 30 could be used. Accessories can be attached to the accessory plate 14 in a number of ways, and can include attachment directly to the accessory or attachment to a bracket or other mounting system that will support the accessory. FIG. 7, for instance, shows the use of a mounting bracket 32 attached to the accessory plate 14 using bolts 34 and nuts 36. Each bolt 34 is placed through an opening 30, and nuts 36 are used to secure the bolts 34 in place. The mounting bracket 32 can then be used to support a number of different accessories, and can have a number of different configurations.

The accessory plate 14 can be removably attached to the base plate 12 in a manner that allows for quick and easy attachment and removal of the accessory plate 14 from the base plate 12, preferably without the use of tools. One structure for providing the quick and easy attachment and removal desired is a lever 16, as shown in FIGS. 1-9. It is advantageous to have the lever 16 integrally formed in the base plate 12 as shown in the figures, however, the lever 16 could be formed in other ways as well. The lever 16 shown includes a notch 22 for securing the accessory plate 14 to the base plate 12.

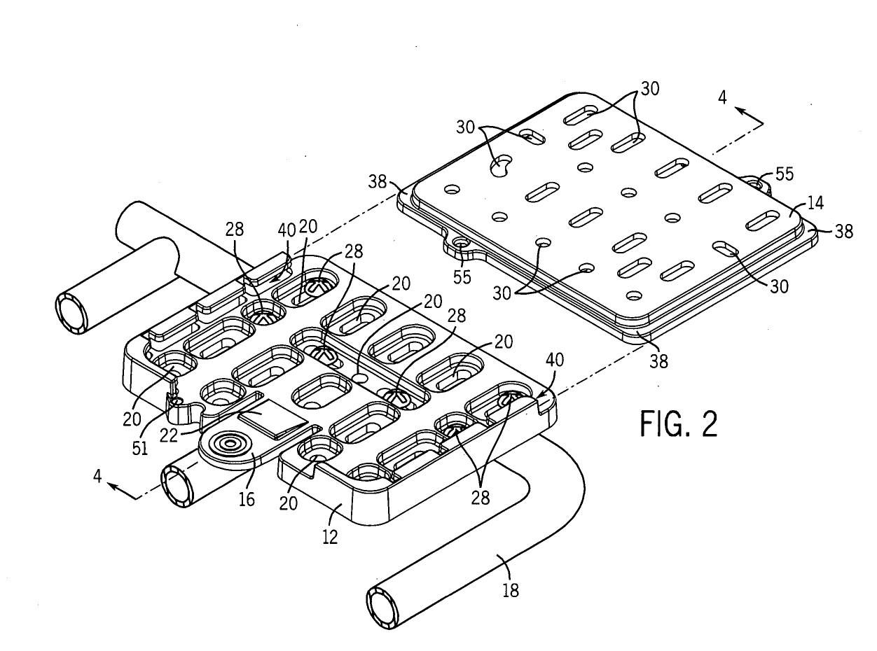

When using a lever 16, the accessory plate 14 can be formed to slidably engage the base plate 12. In FIGS. 1-9, the accessory plate 14 includes a stepped edge 38 that slides into channels 40 on the base plate 12. As best illustrated in FIGS. 1-4, the accessory plate 14 slides in channels 40 until front edge 24 of the accessory plate 14 snaps past the notch 22. Once the front edge 24 snaps past the notch 22, the accessory plate 14 is secured to the base plate 12. The secured position of the accessory plate 14 is shown best in FIGS. 1, 3, and 7. To remove the accessory plate 14 from the base plate 12, the lever 16 is depressed such that the notch 22 is no longer holding the accessory plate 14 in place. When the lever 16 is depressed, the stepped edge 38 of the accessory plate 14 can slide back past the notch 22. Once the stepped edge 38 is back past the notch 22, the accessory plate 14 is released and can slide out of the base plate 12. The accessory is thus easily removed for use, or for replacement by another accessory. The released position of the accessory plate 14 is shown best in FIGS. 2 and 4. The quick-connect apparatus 10 can include a plurality of accessory plates 14 to facilitate the quick and easy replacement of one accessory with another accessory. Each accessory can be attached to a different accessory plate 14 so that exchanging accessories would involve only removing one accessory plate 14 carrying a first accessory with another accessory plate 14 carrying a second accessory.

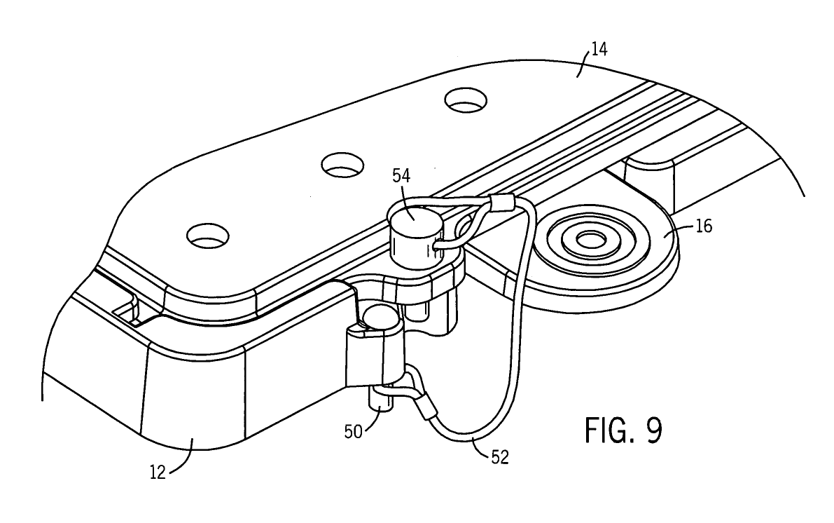

Although the accessory plate 14 is adequately secured to the base plate 12 using a lever 16 as described above, other devices, both in addition to the lever 16 or in place of the lever 16, can be used to secure the accessory plate 14 to the base plate 12. For example, a combination of two or more levers could be used, or a pin and cable fastening device as shown in FIG. 9 could be used in addition to or in place of the lever 16. The pin and cable fastening device in FIG. 9 includes a bolt 50, cable 52 and pin 54. The bolt 50 is inserted through bolt opening 51 (shown in FIG. 2) on the base plate 12 and secured to the vehicle. Pin 54 is connected to bolt 50 by cable 52. To secure the accessory plate 14 to the base plate 12, pin 54 is inserted through pin opening 55 (shown in FIG. 2) in accessory plate 14, as shown in FIG. 9. Several other fastening devices could also be used; however, fastening devices that an operator can fasten and unfasten without the aid of tools are preferred.

In operation, the base plate 12 is attached to the vehicle, and an accessory is attached to the accessory plate 14, either directly or using a mounting system such as mounting bracket 32. The accessory plate 14 is secured to the base plate 12 without using tools, for example, the accessory plate 14 can snap-fit to the base plate 12 as described above wherein the accessory plate 14 slides into the base plate 12 until it snaps past the notch 22. If desired, a secondary securing device such as the pin and cable fastening device described above can be used wherein the pin 54 is inserted through opening 55 in the accessory plate 14. The accessory plate 14 can also be removed from the base plate 12 without the use of tools. For example, the pin 54 can be removed from the pin opening 55 in the accessory plate, and lever 16 can be depressed, allowing accessory plate 14 to slide back past the notch 22 and out of the base plate 12. Other mechanisms for attaching and removing the accessory plate 14 from the base plate 12 that allow the accessory plate 14 to be easily and quickly removed from the base plate 12 could also be used.

The embodiment shown and described is intended for use in connection with an all-terrain vehicle, however, the accessory quick-connect system of the present invention could be used with any vehicle upon which accessories are mounted. In particular, the present invention could also be used with motorcycles, bicycles, and sport utility vehicles.

While the invention has been described with reference to preferred embodiments, those skilled in the art will appreciate that certain substitutions, alterations and omissions may be made to the embodiments without departing from the spirit of the invention. Accordingly, the foregoing description and embodiments discussed are meant to be exemplary only, and should not limit the scope of the invention.

What is claimed is:

1. An accessory quick-connect apparatus for a vehicle, the apparatus comprising:
a base plate adapted for attachment to a vehicle;
at least one accessory plate adapted for attachment to the base plate and to at least one accessory for a vehicle; and
wherein the accessory plate can be attached and removed from the base plate without the use of tools.

2. The quick-connect apparatus of claim 1, further comprising a lever having a notch for attaching and removing the accessory plate from the base plate.

3. The quick-connect apparatus of claim 2, wherein the lever is integrally formed in the base plate.

4. The quick-connect apparatus of claim 1, wherein the accessory plate slidably engages the base plate.

5. An accessory quick-connect system for a vehicle, the system comprising:
a base plate adapted to be attached to a vehicle;
at least one accessory plate formed to slidably engage the base plate and adapted to be attached to accessories for a vehicle; and
a lever for securing and releasing the accessory plate to and from the base plate.

6. The system of claim 5, wherein the lever is integrally formed in the base plate.

7. The system of claim 5, wherein the accessory plate can be attached directly to an accessory or to a mounting system for an accessory.

8. A method for attaching and removing an accessory to and from a vehicle, the method comprising the steps of:
attaching a base plate to a vehicle;
attaching an accessory to an accessory plate;
snap-fitting the accessory plate to the base plate to secure the accessory plate to the base plate;
depressing a lever to release the accessory plate from the base plate; and
removing the accessory plate from the base plate.
